(19) United States
(12) Patent Application Publication
(10) Pub. No.: US 2025/0036262 A1
(43) Pub. Date: Jan. 30, 2025

(54) USER TERMINAL CONTROL METHOD

(71) Applicant: ANTIDOT, LYON (FR)

(72) Inventor: Fabrice LACROIX, SAINTE FOY LES LYON (FR)

(21) Appl. No.: 18/709,259

(22) PCT Filed: Oct. 20, 2022
(86) PCT No.: PCT/FR2022/051992

§ 371 Date: May 10, 2024

(30) Foreign Application Priority Data
Nov. 10, 2021 (FR) FR2111919

(51) Int. Cl. G06F 3/0483; G06F 8/38; G06F 40/103; G06F 40/30; G06Q 10/20

(52) U.S. Cl. CPC G06F 3/0483; G06F 8/38; G06F 40/103; G06F 40/30; G06Q 10/20

(57) ABSTRACT

The present disclosure relates to a computer-implemented method for controlling a user terminal, the method including the steps of: loading a target electronic document comprising a target text in natural language, the target text comprising syntactic markers; and generating an interactive interface based on the target electronic document and comprising the following use modes: a linear mode, in which the interactive interface renders the target text contained in the target electronic document in natural language; a guided mode, in which the interactive interface presents, for a determined step from among the plurality of operating steps, at least one screen page presenting first interface elements corresponding to the at least one attribute of the step, at least one extract from the target text, and at least one second control interface element, corresponding to a link to at least one other step, the at least one second control interface element being configured to allow the passage to a screen page corresponding to said other step following activation of the at least one second control interface element by the user.

### CROSS REFERENCE TO RELATED APPLICATIONS

This application is a National Stage of PCT Application No. PCT/FR2022/051992 filed on Oct. 20, 2022, which claims priority to French Patent Application No. 21/11919 filed on Nov. 10, 2021, the contents each of which are incorporated herein by reference thereto.

### TECHNICAL FIELD

The present disclosure concerns a computer-implemented method for controlling a user terminal, and in particular a computer-implemented method intended to generate an interactive interface in the user terminal from a target text comprised in a target electronic document such as an instruction or maintenance manual.

### BACKGROUND

The instruction or maintenance manuals often contain a significant amount of information, and are moreover difficult to read, and particularly when they are in electronic format. These instruction or maintenance manuals generally describe complex procedures comprising a large number of tasks to be performed. Reading all of these tasks in order to carry out the described procedure can be time-consuming and can in certain cases lead to forgetting a step of the procedure, thus resulting in a critical and sometimes even dangerous situation.

### BRIEF SUMMARY

The present disclosure therefore aims to resolve this technical problem and to secure the carrying out of the procedures described above while reducing the number of errors that may result from incorrect following of the instruction or maintenance manuals.

To this end, the present disclosure relates to a computer-implemented method for controlling a user terminal, the method comprising the following steps of:
loading a target electronic document comprising a target text in natural language, the target text comprising syntactic markers;
dividing the target text into a plurality of analysis fragments, two adjacent analysis fragments being separated by a syntactic marker;
extracting terms of interest from at least one analysis fragment of the plurality of analysis fragments, the terms of interest comprising identified concepts expressed in the target text as well as identified relationships between said concepts;
semantic enriching the target text based on the extracted terms of interest and the division of the target text into analysis fragments;
constructing a computer understandable model based on the division of the target text into a plurality of analysis fragments, syntactic markers, terms of interest and semantic enrichment of the target text, the model comprising a plurality nodes representative of a plurality of operation steps relating to a series of instructions to be carried out and attributes relating to each step of the plurality of operation steps, as well as at least one link between two steps;
generating an interactive interface from the obtained model;

### The Generated Interactive Interface Comprising the Following Using Modes

a linear mode, in which the interactive interface renders the target text comprised in the target electronic document in natural language;
a guided mode, in which the interactive interface presents, for a determined step among the plurality of operation steps, at least one screen page presenting first interface elements corresponding to the at least one attribute of the step, at least one extract from the target text, and at least one second control interface element corresponding to a link to at least one other step, the at least one second control interface element being configured to allow the passage to a screen page corresponding to said other step following an activation of the at least one second control interface element by the user.

Advantageously, the described computer-implemented method makes it possible to generate an interactive interface from a target text, said interactive interface allowing two using modes of the interactive interface which can be adapted to a given using need.

The device may also include one or more of the characteristics described below.

The computer-implemented method may comprise a step of introducing into the target text additional syntactic markers in addition to the syntactic markers comprised in the target text.

Advantageously, the introduction of additional syntactic markers makes it possible to better divide the target text into analysis fragments in order to obtain a structure of the target text that is more easily convertible into a presentation of the plurality of operation steps in a progressive and guided manner, in other words step by step in guided mode.

The interactive interface can be configured to allow a switching between the linear mode and the guided mode.

Advantageously, the switching of the interactive interface makes it easier to read a series of instructions.

The interactive interface may comprise the at least one second control interface element configured to allow, if the interactive interface presents a screen page corresponding to a current step, to move to a screen page corresponding to a next step or a previous step compared to the current step.

Advantageously, the at least one second control interface element allows a navigation between different steps of the plurality of operation steps of the target text comprised in the target electronic document.

The interactive interface can be configured to allow, in guided mode, and when the interactive interface presents a screen page corresponding to the current step, a communication of an alert message or a part of text of the target text relating to said current step or to a step comprised in the plurality of operation steps other than the current step.

Advantageously, the communication of an alert message or a part of text of the target text relating to said current step or to a step comprised in the plurality of operation steps other than the current step makes it possible to make the interactive interface easier to use by allowing a memorization of the last presented step, or display precautions to take or conditions to meet before starting to carry out the current step, such as displaying a message indicating that a safety helmet must be worn before starting to carry out the current step.

The interactive interface can be configured, in guided mode, to present, if the interactive interface displays the screen page corresponding to the current step, a multimedia support relating to the current step.

Advantageously, the presentation of the multimedia support relating to the current step makes it possible to enrich the extract of the target text with the multimedia support in order to facilitate the understanding of the target text.

The interactive interface can be configured to allow the user to add to a screen page displayed by the interactive interface the multimedia support or a support text, said multimedia support or said support text comprising support information intended to facilitate the executing of the plurality of operation steps relating to the series of instructions to be carried out.

Advantageously, if the interactive interface is configured to allow the user to add multimedia support or support text to a screen page displayed by the interactive interface, the user can keep a written or visual trace of information that it considers important for the execution of the plurality of operation steps relating to the series of instructions to be carried out.

The interactive interface can be configured to memorize the screen page corresponding to the current step, so that, if the interactive interface is stopped then restarted, the interactive interface presents, upon restarting, the screen page corresponding to the step which was the current step before stopping the interactive interface.

Advantageously, the memorization by the interactive interface of the current step in which the user is located makes it easier to resume the method implemented by the user.

The interactive interface can be configured to retain the target text comprised in the target electronic document and to present said target text in natural language in linear mode, and in a progressive and guided manner in guided mode.

Advantageously, the conservation by the interactive interface of the target text comprised in the target electronic document allows the access to this target text despite a presentation in guided mode.

The user can select in the interactive interface, in linear mode, a plurality of operation steps relating to a series of instructions to be carried out, said plurality of operation steps relating to a series of instructions to be carried out corresponding to analysis fragments of the plurality of analysis fragments, and the interactive interface displays, based on the selection made by the user, attributes relating to each step of the plurality of operation steps selected by the user, said attributes corresponding to the extracted terms of interest.

Advantageously, the display by the interactive interface of the attributes relating to each step of the plurality of operation steps selected by the user allows the user to have knowledge of all the attributes relating to the plurality of operation steps selected by the user prior to carrying out the plurality of operation steps, such as for example having knowledge of a list of tools or spare parts to prepare to carry out a given maintenance intervention.

A term of interest extracted from an analysis fragment of the plurality of analysis fragments may designate a verb which refers to an action to be performed, or a tool used when carrying out said action, or a product used when carrying out said action.

Advantageously, this allows the construction of a knowledge graph based on the extracted terms of interest and highlight important information for the user.

The target electronic document may designate a maintenance notice for a device, a system or a given installation and the target text designates a series of instructions to be carried out for the maintenance of said device, said system or said installation.

Advantageously, this makes it possible to carry out a maintenance on a device, a system or a given installation in a simple and rapid manner.

The target electronic document may designate a user manual of a device, a system or a given installation and the target text may designate a series of instructions to be carried out to handle or operate said device, said system or said installation.

Advantageously, this makes it possible to handle or operate a device, a system or a given installation in a simple and quick manner.

Other advantages and characteristics may emerge from the detailed description which follows.

### BRIEF DESCRIPTION OF THE DRAWINGS

The present disclosure will be better understood on reading the detailed description which follows, given solely by way of non-limiting example and made with reference to the appended drawings listed below.

FIG. 1 represents a flowchart of the different steps of the described computer-implemented method.

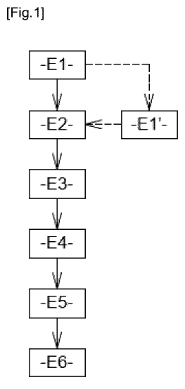

FIG. 2 represents an extract from a target document comprising a target text to be loaded into a user terminal.

FIG. 3 represents two screen pages of the user terminal presenting two linear and guided operating modes of an interactive interface generated from the target text presented in FIG. 2.

FIG. 4 represents a screen page of the user terminal comprising a checklist of attributes relating to an execution of a given step of a task to be performed.

FIG. 5 represents a screen page of the user terminal presenting an alert message, and another screen page presenting multimedia support relating to the step presented in FIG. 4.

FIG. 6 represents a screen page of the user terminal presenting multimedia support and support text added by a user.

FIG. 7a represents an example of a target electronic document which comprises several text passages

FIG. 7b represents an example of decomposition of the target electronic document of FIG. 7a into an organized sequence of analysis fragments according to the described computer-implemented method.

FIG. 8 shows an example of a step of extracting terms of interest in the target text according to the described computer-implemented method.

In these figures, the same references are used to designate the same elements. The elements represented in the different figures are not necessarily made to scale in order to facilitate the understanding of the figures.

### DETAILED DESCRIPTION

The present disclosure concerns a computer-implemented method for controlling a user terminal. The described method comprises a step of loading E1 a target electronic document 1 comprising a target text 2 in natural language, the target text comprising syntactic markers 3. By syntactic marker 3 is meant a text formatting indicator, this formatting indicator that can be visible to the human eye as for example a punctuation mark or invisible to the human eye such as an internal tag in the target text 2 for example.

The computer-implemented method further comprises a step E2 of dividing the target text 2 into a plurality of analysis fragments, two adjacent analysis fragments being separated by a syntactic marker 3. By analysis fragment is meant a subset of target text 2 as a paragraph extracted from the target text 2.

Then, the computer-implemented method comprises a step E3 of extracting terms of interest 5 from at least one analysis fragment 4 of the plurality of analysis fragments, the terms of interest 5 comprising identified concepts expressed in the target text 2 as well as identified relationships between said concepts. A term of interest 5 extracted from an analysis fragment 4 of the plurality of analysis fragments can designate a verb which refers to an action to be performed, or a tool used when carrying out said action, or a product used when carrying out said action. The terms of interest 5 can designate, for example, actions to be carried out or useful tools for carrying out these actions.

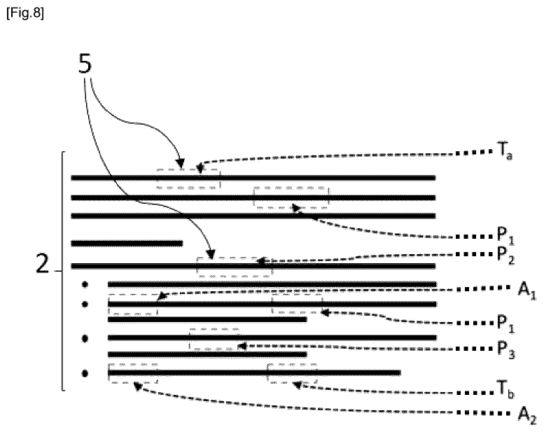

FIG. 8 shows an example of this extraction step E3 of terms of interest 5 in the target text 2, the terms of interest in FIG. 8 designating a set of tools Ta, Tb and components P1, P2, P3 and actions to be carried out A1, A2.

The identified concepts comprised in the terms of interest 5 can be identified automatically, in other words by using automatic learning algorithms, for example of the Deep Learning type, SVM, CRF, etc.

The computer-implemented method also comprises a semantic enrichment step E4 of the target text 2 on the basis of the extracted terms of interest 5 and the division E2 of the target text 2 into analysis fragments 4 and a construction step E5 of a model understandable by computer on the basis of the division E2 of the target text 2 into a plurality of analysis fragments, the syntactic markers 3, the terms of interest 5 and the semantic enrichment E4 of the target text 2, the model comprising a plurality of nodes representative of a plurality of operation steps relating to a series of instructions to be carried out and attributes 6 relating to each step of the plurality of operation steps, as well as at least one link between two steps.

The model constructed on the basis of the division E2 of the target text 2 into a plurality of analysis fragments 4 and syntactic markers 3 may comprise a code understandable by computer.

The model obtained after converting the terms of interest 5 can designate a knowledge graph.

Advantageously, the construction E5 of the knowledge graph on the basis of the extracted terms of interest 5 makes it possible to highlight important information for the user of the user terminal.

The knowledge graph makes it possible to navigate between the identified concepts, in particular in order to determine which tools are necessary to carry out a given task and which checks must be carried out before starting said given task.

The concepts comprised in the terms of interest 5 can designate action verbs for example, and the relationships identified between said concepts can designate a relationship of simultaneity or succession between two action verbs for example.

The described computer-implemented method moreover comprises a generation step E6 of an interactive interface 8 from the obtained model.

During the generation step E6, the method comprises the generation, for a determined step among the plurality of operation steps of the model, of at least one screen page 10 including first interface elements 11 corresponding to at least one attribute of the step, at least one extract from the target text 2, and at least one second control interface element 7,12 corresponding to a link to at least one other step, the at least one second control interface element 7,12 being configured to allow passage to a screen page corresponding to said other step following an activation of the at least one second control interface element 7,12 by the user.

### The Generated Interactive Interface 8 Comprises the Following Using Modes

a linear mode 9, in which the interactive interface 8 renders the target text 2 comprised in the target electronic document 1 in natural language;
a guided mode 9′, in which the interactive interface 8 presents, for a determined step among the plurality of operation steps, the at least one screen page presenting, as described above, first interface elements 11, and at least one second control interface element 7,12 configured to allow passage to a screen page corresponding to said other step following an activation of the at least one second control interface element 7,12 by the user.

Thus, the control method can comprise the passage from a screen page corresponding to a first step of the plurality of operation steps to another screen page corresponding to another step of the plurality of operation steps following an activation of the at least one second control interface element 7,12 by the user.

According to the terms of the present disclosure, a natural language designates a text written in a form and an order intended for a classic linear reading by a human being, in other words a text written in paragraphs, sections and pages for example.

The first interface elements 11 are text areas possibly identified in the interactive interface 8.

The at least one second control interface element 7,12 can designate a button or link in the interactive interface 8.

In linear mode 9, the interactive interface 8 renders the target text 2 comprised in the target electronic document 1 in natural language, in a reading order identical to a reading order of the target text 2 comprised in the target document 1, in other words following a continuous and ordered reading of the target text or a line-by-line reading of the target text 2.

In guided mode 9′, the interactive interface 8 presents the plurality of operation steps in a progressive and guided manner, in other words step by step.

The interactive interface 8 can be configured to allow a switching between the linear mode 9 and the guided mode 9′.

Advantageously, the switching of the interactive interface 8 makes it possible to facilitate reading and carrying out of a series of instructions, by allowing a transition from a linear and continuous reading of the target text to a guided configuration which guides the user in the instructions to be carried out.

The switching between the linear mode 9 and the guided mode 9′ can occur following a command from the user of the interactive interface 8, and for example following the user pressing an interactive interface element such as a button 13.

The terms «user», «user of the interactive interface» and «user of the user terminal» can designate the same person.

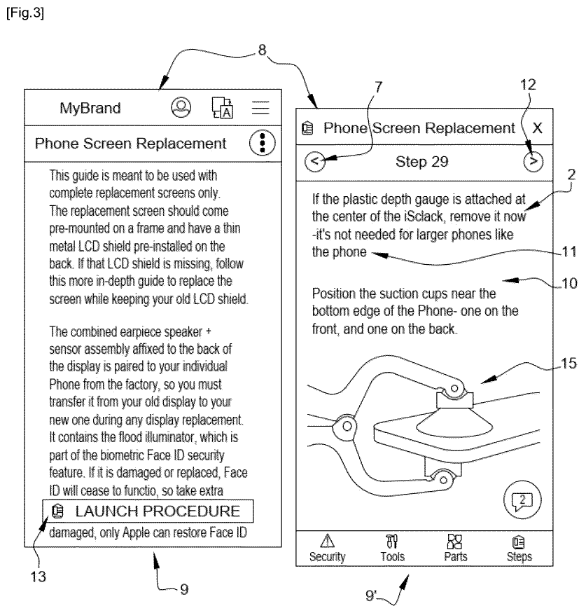

For example, in FIG. 3 we can see two screen pages of the user terminal presenting two linear 9 and guided 9′ operating modes, and the switching between these two pages is carried out following the pressing of the user of the interactive interface 8 on the button 13.

According to one implementation mode, the switching between the linear mode 9 and the guided mode 9′ can occur following a voice command given to the user terminal.

The interactive interface 8 can be configured to retain the target text 2 comprised in the target electronic document 1 and to present said target text 2 in natural language in linear mode 9, as is the case in the first page of the user terminal of FIG. 3, and in a progressive and guided manner in guided mode 9′ as is the case in the second page of the user terminal of FIG. 3.

Advantageously, the conservation by the interactive interface 8 of the target text 2 comprised in the target electronic document 1 allows the access to this target text 2 despite a presentation in guided mode 9′.

The interactive interface 8 can comprise, as shown in FIG. 3, the at least one second control interface element 7, 12 configured to allow, if the interactive interface 8 presents a screen page corresponding to a current step, to move to a screen page corresponding to a next step or a previous step in relation to the current step.

Advantageously, the at least one second control interface element 7,12 allows a navigation between different steps of the plurality of operation steps of the target text comprised in the target electronic document.

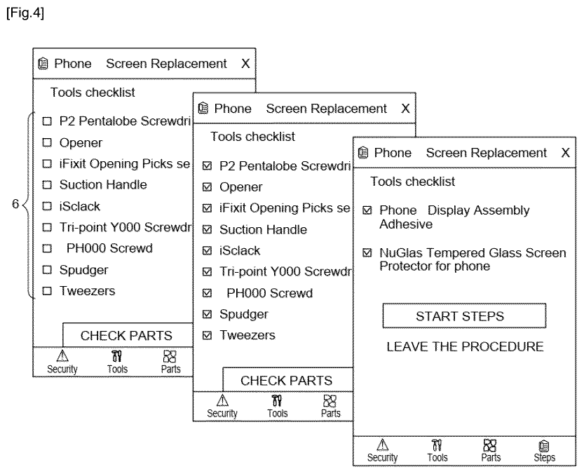

The interactive interface 8 can be configured to present, prior to the user terminal displaying a screen page presenting a given step comprised in a procedure to be carried out, a checklist of attributes relating to said given step. For example, in FIG. 4, a checklist of various tools and another checklist of various components necessary for carrying out a procedure for changing a telephone screen are presented prior to displaying the procedure changing the phone screen.

The interactive interface 8 can be configured to memorize the screen page corresponding to the current step, so that, if the interactive interface 8 is stopped then restarted, the interactive interface 8 presents, upon restarting, the corresponding screen page to the step which was the current step before stopping the interactive interface 8.

Advantageously, the memorization by the interactive interface 8 of the current step in which the user is located makes it possible to facilitate the resumption of the method implemented by the user.

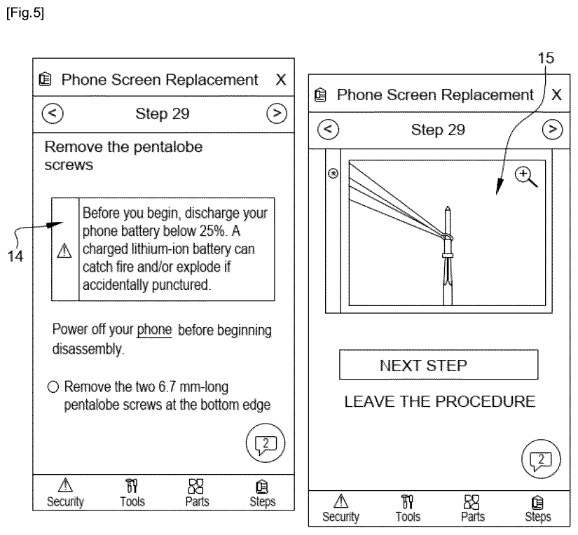

The interactive interface 8 can be configured to allow, in guided mode 9′, and when the interactive interface 8 presents a screen page corresponding to the current step, communication of an alert message 14 such as the alert 14 in FIG. 5 or a part of text of the target text 2 relating to said current step or to a step comprised in the plurality of operation steps other than the current step.

Advantageously, the communication of the alert message 14 or of the part of the text of the target text 2 relating to said current step or to a step comprised in the plurality of operation steps other than the current step makes it possible to facilitate the use of the interactive interface 8 by allowing a memorization of the last presented step, or displaying precautions to be taken or conditions to be fulfilled before starting to carry out the current step, such as for example displaying an alert message indicating that a safety helmet must be worn before starting to carry out the current step.

The interactive interface 8 is configured, in guided mode 9′, to present, if the interactive interface 8 displays the screen page corresponding to the current step, a multimedia support 15 relating to the current step.

The multimedia support 15 can designate a photo or a video for example, relating to the extract of the target text 2 presented in the current step.

Advantageously, the presentation of the multimedia support 15 relating to the current step makes it possible to enrich the extract of the target text with the multimedia support 15 in order to facilitate the understanding of the target text 2.

The user can select in the interactive interface 8, in linear mode 9, a plurality of operation steps relating to the series of instructions to be carried out, said plurality of operation steps relating to the series of instructions to be carried out corresponding to analysis fragments 4 of the plurality of analysis fragments, and the interactive interface 8 displays, on the basis of the selection made by the user, attributes 6 relating to each step of the plurality of operation steps selected by the user, said attributes 6 corresponding to the extracted terms of interest 5.

Advantageously, the display by the interactive interface 8 of the relative attributes 6 at each step of the plurality of operation steps selected by the user allows the user to have knowledge of all the attributes 6 relating to the plurality of operation steps selected by the user prior to carrying out the plurality of operation steps, such as for example having knowledge of a list of tools or spare parts to be prepared to carry out a given maintenance intervention.

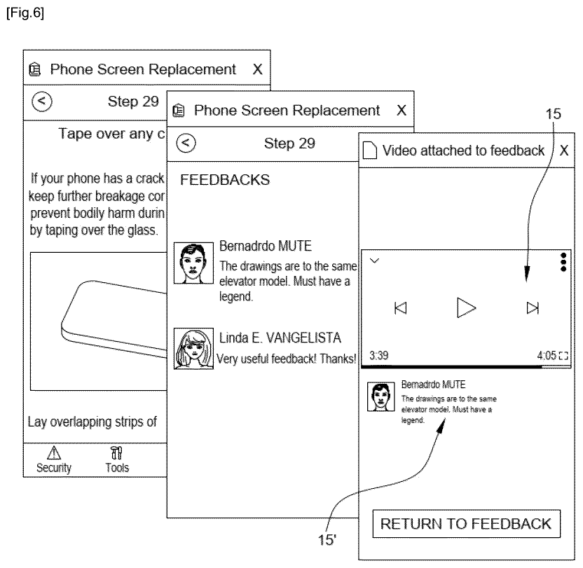

The interactive interface 8 can be configured to allow the user to add to a screen page displayed by the interactive interface 8 the multimedia support 15 or a support text 15′ (FIG. 6), said multimedia support 15 or said text support 15′ comprising support information intended to facilitate the execution of the plurality of operation steps relating to the series of instructions to be carried out.

Advantageously, if the interactive interface 8 is configured to allow the user to add to a screen page displayed by the interactive interface 8 the multimedia support 15 or the support text 15′, the user can keep a written or visual track of information that it considers important for the execution of the plurality of operation steps relating to the series of instructions to be carried out.

The described computer-implemented method may further comprise a step of introducing E1′ into the target text 2 of additional syntactic markers added to the syntactic markers 3 comprised in the target text 2 prior to the dividing step E2 of the target text 2 into a plurality of analysis fragments. In this case, two adjacent analysis fragments are separated by a syntactic marker 3 or an additional syntactic marker.

Advantageously, the introduction E1′ of additional syntactic markers makes it possible to better divide the target text 2 into analysis fragments 4 in order to obtain a structure of the target text that is more easily convertible into a presentation of the plurality of operation steps in a progressive and guided manner, in other words step by step in guided mode 9.

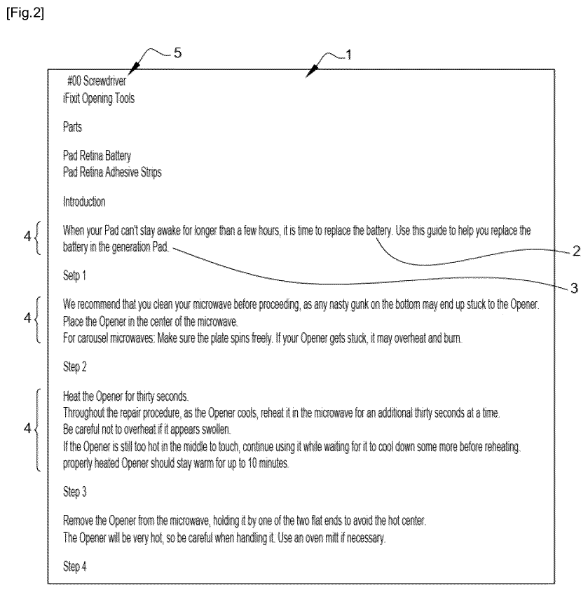

FIG. 2 shows an example of target electronic document 1 comprising the target text 2. This target electronic document 1 comprises the analysis fragments 4, as well as the syntactic markers 3. The target electronic document 1 also comprises the terms of interest 5.

The target electronic document 1 may comprise, in addition to the target text 2, images and other multimedia supports which can, for example, help to better understand the target text 2.

The target electronic document 1 may comprise a plurality of primary electronic documents and the target text 2 may designate passages of text extracted from at least one of the plurality of primary electronic documents. In other words, the target electronic document 1 may comprise a collection of text passages, each text passage of the collection of text passages being extracted from a different text source.

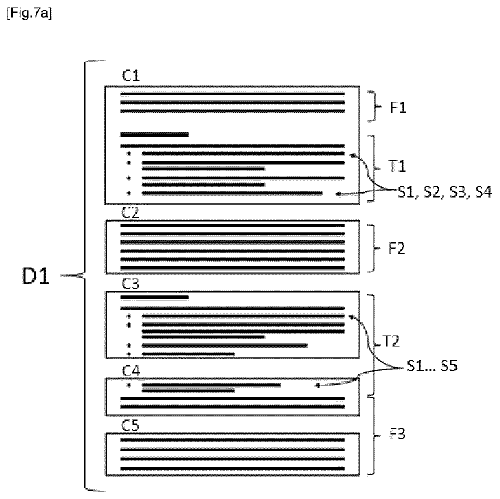

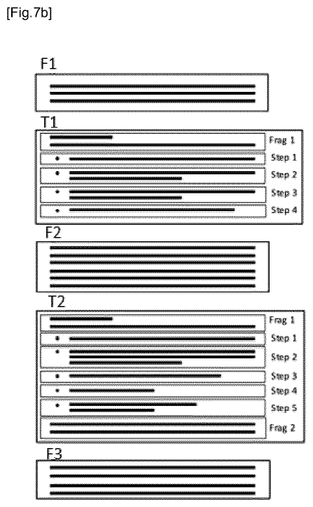

For example, in FIG. 7a, the document D₁ designates a target electronic document which comprises the text passages denoted C₁, C₂, C₃, C₄ and C₅. Note in this case that D₁ is the concatenation or sum of the different passages of text according to the equation:

D₁=C₁+C₂+C₃+C₄+C₅

The described control method can analyze the document D₁ and extract the operations T₁, T₂, the analysis fragments F₁, F₂ as well as the operation steps S₁, S₂, S₃, S₄, S₅ to be carried out to obtain a decomposition of the document D₁ presented in FIG. 7b, where D₁ is the combined sum of operations T₁, T₂, analysis fragments F₁, F₂ and operation steps S₁, S₂, S₃, S₄, S₅ to be performed and which can be put in the form of the following equation:

D₁=F₁+T₁=[T₁F₁+T₁S₁+T₁S₂+T₁S₃+T₁S₄]+F₂+T₂[=T₂F₁+T₂S₁+T₂S₂+T₂S₃+T₂S₄+T₂S₅+T₂F₂]+F₃

The target electronic document 1 may designate a maintenance notice for a device, a system or a given installation and the target text 2 may designate a series of instructions to be carried out for the maintenance of said device, said system or said installation.

Advantageously, this allows maintenance of said device, said system or said installation to be carried out simply and quickly.

The target electronic document 1 may designate a user manual of a device, a system or a given installation and the target text 2 designates a series of instructions to be carried out to handle or operate said device, said system or said installation.

Advantageously, this allows the device, system or installation to be handled or operated simply and quickly.

By way of example, the target electronic document 1, which may be a notice describing a process for replacing a mobile telephone screen intended for an operator and comprising the target text 2 which may designate the series of instructions to be carried out for the replacement of the mobile phone screen by the operator, can be loaded into the user terminal which, in this example, denotes a smartphone.

The smartphone then presents an interactive interface 8 which displays the target text 2 in a linear manner in the linear mode 9 as shown on the first screen page of FIG. 3. Pressing the button 13 allows switching the interactive interface 8 in the guided mode 9′ presented in the second screen page of FIG. 3. In this guided mode 9′, the series of instructions to be carried out relating to a given step of the process for replacing the mobile phone screen is accompanied by the multimedia support 15. You can also move on to a next or previous step in the process for replacing the mobile phone screen by pressing the at least one second control interface element 7,12.

When moving to a next step, the interactive interface 8 can display the checklist of different tools and the checklist of different components prior to the start of the next step as presented in FIG. 4: the operator can then check that he has at his disposal the tools and components necessary to carry out the next step.

During the next step, the alert message 14 warns the operator of a particular precaution to take such as for example discharging the battery of the mobile phone to less than 25% in order to avoid overheating of the battery of said mobile phone when replacing the screen of said mobile phone.

The interactive interface 8 offers the operator the possibility of including, on his own initiative, the multimedia support 15 (a video support) or the support text 15′ (a support note) as is the case in FIG. 6. For example, if to replace the mobile phone screen, the operator must use specific pliers stored in a locked cabinet, then the operator, thanks to the guided mode 9′ of the interactive interface 8, will be able to insert the support note in the screen page displayed by the interactive interface 8, the support note indicating for example the location of said cabinet key.

According to one possibility, the operator can select the plurality of operation steps that he would like to carry out in the process for replacing the mobile phone screen, and the interactive interface displays, based on the selection made by the operator, the list of tools and components that he would need to carry out the plurality of selected operation steps.

The computer-implemented method therefore allows the operator to carry out the process for replacing the mobile phone screen quickly and efficiently.

Advantageously, the described computer-implemented method makes it possible to facilitate reading of the target electronic document 1 comprising the target text 2 by generating the interactive interface 8 which allows two modes of use of the interactive interface 8 which can be adapted to the given need of use.

Advantageously, the described computer-implemented method makes it possible to control the user terminal so that said user terminal displays a procedure to follow in a guided manner, said procedure to follow being initially comprised in the target text 1 in a linear manner.

Advantageously, the described computer-implemented method makes it possible to guide the user of the user terminal in the procedure to follow without modifying the content of the target text 1 comprised in the target electronic document 2.

Advantageously, the described computer-implemented method uses text mining, in order to analyze the target text 2 comprised in the target electronic document 1 and to generate the interactive interface 8 which makes it possible to guide the user of the user terminal in the procedure to follow, this procedure to follow may be a maintenance or replacement procedure for a part comprised in a given machine or device.

1. A computer-implemented method for controlling a user terminal, the method comprising the following steps of:
loading a target electronic document comprising a target text in natural language, the target text comprising syntactic markers;
dividing the target text into a plurality of analysis fragments, two adjacent analysis fragments being separated by a syntactic marker;
extracting terms of interest from at least one analysis fragment of the plurality of analysis fragments, the terms of interest comprising identified concepts expressed in the target text as well as identified relationships between the identified concepts;
semantic enriching the target text on the basis of the terms of interest extracted and the division of the target text into analysis fragments;
constructing a model understandable by computer based on the division of the target text into the plurality of analysis fragments, the syntactic markers, the terms of interest and the semantic enrichment of the target text, the model comprising a plurality of nodes representative of a plurality of operation steps relating to a series of instructions to be carried out and attributes relating at each step of the plurality of operation steps, as well as at least one link between two steps;
generating an interactive interface from the obtained model;
the generated interactive interface comprising the following using modes:
a linear mode, in which the interactive interface renders the target text comprised in the target electronic document in natural language;
a guided mode, in which the interactive interface presents, for a determined step among the plurality of operation steps, at least one screen page presenting first interface elements corresponding to at least one attribute of the step, at least one extract of the target text, and at least one second control interface element corresponding to a link to at least one other step, the at least one second control interface element being configured to allow passage to a screen page corresponding to said the at least one other step following an activation of the at least one second control interface element by a user.

2. The method according to claim 1 further comprising a step of introducing into the target text additional syntactic markers in addition to the syntactic markers comprised in the target text.

3. The method according to claim 1, wherein the interactive interface is configured to allow a switching between linear mode and guided mode.

4. The method according to claim 1, wherein the interactive interface comprises at least one second control interface element configured to allow, if the interactive interface presents a screen page corresponding to a current step, to move to a screen page corresponding to a next step or a previous step in relation to the current step.

5. The method according to claim 1, wherein the interactive interface is configured to allow, in guided mode, and when the interactive interface presents a screen page corresponding to a current step, a communication of an alert message or a text part of the target text relating to a current step or to a step comprised in the plurality of operation steps other than the current step.

6. The method according to claim 1, wherein the interactive interface is configured, in guided mode, to present, if the interactive interface displays the screen page corresponding to a current step, a multimedia support relating to the current step.

7. The method according to claim 6, wherein the interactive interface is configured to allow the user to add to a screen page displayed by the interactive interface the multimedia support or a support text, the multimedia support or the support text comprising support information intended to facilitate the execution of the plurality of operation steps relating to the series of instructions to be carried out.

8. The method according to claim 1, wherein the interactive interface is configured to memorize the screen page corresponding to a current step, so that, if the interactive interface is stopped then restarted, the interactive interface presents, as soon as it is restarted, the screen page corresponding to the step which was the current step before stopping the interactive interface.

9. The method according to claim 1, wherein the interactive interface is configured to retain the target text comprised in the target electronic document and to present the target text in natural language in linear mode, and in a progressive and guided manner in guided mode.

10. The method according to claim 1, wherein the user can select in the interactive interface, in linear mode, a plurality of operation steps relating to a series of instructions to be carried out, the plurality of operation steps relating to a series of instructions to be carried out corresponding to analysis fragments of the plurality of analysis fragments, and the interactive interface displays, on a basis of a selection made by the user, attributes relating to each step of the plurality of operation steps selected by the user, the attributes corresponding to the extracted terms of interest.

11. The method according to claim 1, wherein a term of interest extracted from an analysis fragment of the plurality of analysis fragments designates a verb which refers to an action to be carried out, or a tool used when carrying out the action, or a product used when carrying out the action.

12. The method according to claim 1, wherein the target electronic document designates a maintenance notice for a device, a system or a given installation and the target text designates a series of instructions to be carried out for the maintenance notice of the device, the system or the installation.

13. The method according to claim 1, wherein the target electronic document designates a user manual for a device, a system or a given installation and the target text designates a series of instructions to be carried out to handle or operate the device, the system or the installation.

14. The method according to claim 2, wherein the interactive interface is configured to allow a switching between linear mode and guided mode.

15. The method according to claim 14, wherein the interactive interface comprises at least one second control interface element configured to allow, if the interactive interface presents a screen page corresponding to a current step, to move to a screen page corresponding to a next step or a previous step in relation to the current step.

16. The method according to claim 15, wherein the interactive interface is configured to allow, in guided mode, and when the interactive interface presents a screen page corresponding to a current step, a communication of an alert message or a text part of the target text relating to a current step or to a step comprised in the plurality of operation steps other than the current step.

17. The method according to claim 16, wherein the interactive interface is configured, in guided mode, to present, if the interactive interface displays the screen page corresponding to a current step, a multimedia support relating to the current step.

18. The method according to claim 17, wherein the interactive interface is configured to allow the user to add to a screen page displayed by the interactive interface the multimedia support or a support text, the multimedia support or the support text comprising support information intended to facilitate the execution of the plurality of operation steps relating to the series of instructions to be carried out.

19. The method according to claim 18, wherein the interactive interface is configured to memorize the screen page corresponding to a current step, so that, if the interactive interface is stopped then restarted, the interactive interface presents, as soon as it is restarted, the screen page corresponding to the step which was the current step before stopping the interactive interface.

20. The method according to claim 19, wherein the interactive interface is configured to retain the target text comprised in the target electronic document and to present the target text in natural language in linear mode, and in a progressive and guided manner in guided mode.
